(19) United States
(12) Patent Application Publication
(10) Pub. No.: US 2024/0190420 A1
(43) Pub. Date: Jun. 13, 2024

(54) METHOD AND APPARATUS OF PREDICTING POSSIBILITY OF ACCIDENT IN REAL TIME DURING VEHICLE DRIVING

(71) Applicant: ELECTRONICS AND TELECOMMUNICATIONS RESEARCH INSTITUTE, Daejeon (KR)

(72) Inventors: Kyung Bok Sung, Daejeon (KR); Kyoung-Wook Min, Daejeon (KR); Jeong-Woo Lee, Daejeon (KR); Jeong Dan CHOI, Daejeon (KR)

(21) Appl. No.: 18/519,203

(22) Filed: Nov. 27, 2023

(30) Foreign Application Priority Data
Dec. 13, 2022 (KR) 10-2022-0173815
Oct. 18, 2023 (KR) 10-2023-0139674

(51) Int. Cl. B60W 30/09; B60W 50/00; B60W 50/06; B60W 60/00; G05B 13/02; G08G 1/16

(52) U.S. Cl. CPC B60W 30/09; B60W 50/0097; B60W 50/06; B60W 60/0015; G05B 13/0265; G08G 1/161; B60W 2556/45

(57) ABSTRACT

A method of predicting a possibility of an accident is provided. The method includes abstracting surrounding situation data and movement data of an ego-vehicle input from a sensor to generate abstracted driving situation data by using an abstraction module executed by a processor, calculating a digitized score of a possibility of an accident of the ego-vehicle by using a calculation module executed by the processor, based on the abstracted driving situation data, and generating action data of the ego-vehicle for decreasing the possibility of the accident by using an action generating module executed by the processor, based on the score.

### CROSS-REFERENCE TO RELATED APPLICATIONS

This application claims the benefit of the Korean Patent Application No. 10-2022-0173815 filed on Dec. 13, 2022, and 10-2023-0139674 filed on Oct. 18, 2023, which are hereby incorporated by reference as if fully set forth herein.

### BACKGROUND

### 1. Field of the Invention

The present invention relates to technology for predicting a possibility of an accident in real time during vehicle driving.

### 2. Description of Related Art

Much research for preventing traffic accidents associated with autonomous driving is being done, but a traffic accident occurrence rate is not reduced still. Autonomous driving technology developed to date has a limitation in preventing all of various types of traffic accidents.

Autonomous vehicles may not prevent all of various types of traffic accidents, but when autonomous vehicles learn a similarity between similar types of traffic accidents, an accident possibility of similar types of traffic accidents may be predicted based on at least learned similarity and a traffic accident may be predicted based on the predicted accident possibility. Therefore, it is required to develop a system which may learn a similarity between similar types of traffic accidents to predict an accident possibility of similar types of traffic accidents.

### SUMMARY

An aspect of the present invention is directed to providing an apparatus and method of predicting a possibility of an accident in real time during vehicle driving, which may calculate an accident risk level by using a calculation module which abstracts a driving situation of similar types of traffic accidents and learns a possibility of an accident on the basis of the abstracted driving situation.

The advantages, features and aspects of the present invention will become apparent from the following description of the embodiments with reference to the accompanying drawings, which is set forth hereinafter.

To achieve these and other advantages and in accordance with the purpose of the invention, as embodied and broadly described herein, there is provided a method of predicting a possibility of an accident, the method including: abstracting surrounding situation data and movement data of an ego-vehicle input from a sensor to generate abstracted driving situation data by using an abstraction module executed by a processor; calculating a digitized score of a possibility of an accident of the ego-vehicle by using a calculation module executed by the processor, based on the abstracted driving situation data; and generating action data of the ego-vehicle for decreasing the possibility of the accident by using an action generating module executed by the processor, based on the score.

A method of learning a possibility of an accident according to an embodiment of the present invention includes: collecting vehicle accident data by using a collection module controlled by a processor; abstracting the vehicle accident data to generate abstracted driving situation data by using an abstraction module controlled by the processor; training a prediction function to calculate a score representing a possibility of an accident of an ego-vehicle by using the abstracted driving situation data as learning data in a learning module controlled by the processor; and transmitting the trained prediction function to the ego-vehicle to install the trained prediction function in a calculation module of the ego-vehicle by using a communication device controlled by the processor.

An apparatus for predicting a possibility of an accident according to an embodiment of the present invention includes: a processor; an abstraction module executed by the processor and configured to abstract surrounding situation data and movement data of an ego-vehicle input from a sensor to generate abstracted driving situation data; a calculation module executed by the processor and configured to calculate a digitized score of a possibility of an accident of the ego-vehicle, based on the abstracted driving situation data; and an action generating module executed by the processor and configured to generate action data of the ego-vehicle for decreasing the possibility of the accident, based on the score.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a block diagram of a whole system for predicting a possibility of an accident in real time during vehicle driving, according to an embodiment of the present invention.

FIG. 2 is a diagram for describing environment data abstracted by an abstraction module of FIG. 1.

FIG. 3 is a diagram for describing action data abstracted by the abstraction module of FIG. 1.

FIG. 4 is a diagram for describing a first accident score, a second accident score, and a final accident score each calculated by a prediction function according to an embodiment of the present invention.

FIG. 5 is a flowchart for describing a method of predicting a possibility of an accident in real time during vehicle driving, according to an embodiment of the present invention.

FIG. 6 is a flowchart for describing a method of learning a possibility of an accident during vehicle driving, according to an embodiment of the present invention.

### DETAILED DESCRIPTION OF THE INVENTION

Hereinafter, the present invention may have diverse modified embodiments, and thus, preferred embodiments are illustrated in the drawings and are described in the detailed description of the present invention. However, this does not limit the present invention within specific embodiments and it should be understood that the present invention covers all the modifications, equivalents, and replacements within the idea and technical scope of the present invention. Like reference numerals refer to like elements throughout. It will be understood that although the terms including an ordinary number such as first or second are used herein to describe various elements, these elements should not be limited by these terms. These terms are only used to distinguish one element from another element. In the following description, the technical terms are used only for explain a specific exemplary embodiment while not limiting the present invention. The terms of a singular form may include plural forms unless referred to the contrary.

In the present document, expression “A or B”, “at least one of A and/or B”, or “A/B” may include all possible combinations of listed items. Expressions “first,”, “second,”, and “first,” or “second,” may modify corresponding elements regardless of an order or significance and may be used for differentiating one element from the other element, but does not limit corresponding elements. When an element (for example, first) is described as “being (functionally or in communication) connected with” or “accessing” another element (for example, second), the element may be directly connected with the other element, or may be connected with the other element through a different element (for example, a third element).

In the present document, “configured to˜” may be used interchangeably with “suitable for˜”, “having ability˜”, “changed to perform˜”, “provided to perform˜”, “able˜”, or “designed to perform˜”, based on a situation (for example, in hardware or software).

In an arbitrary situation, expression “device configured to perform˜” may denote that the device “may perform˜” together with another device or parts. For example, a phrase “processor configured (or set) to perform A, B, and C” may denote a dedicated processor (for example, an embedded processor) for performing a corresponding operation or a general-use processor (for example, a central processing unit (CPU) or an application processor) which may execute one or more software programs stored in a memory device to perform corresponding operations.

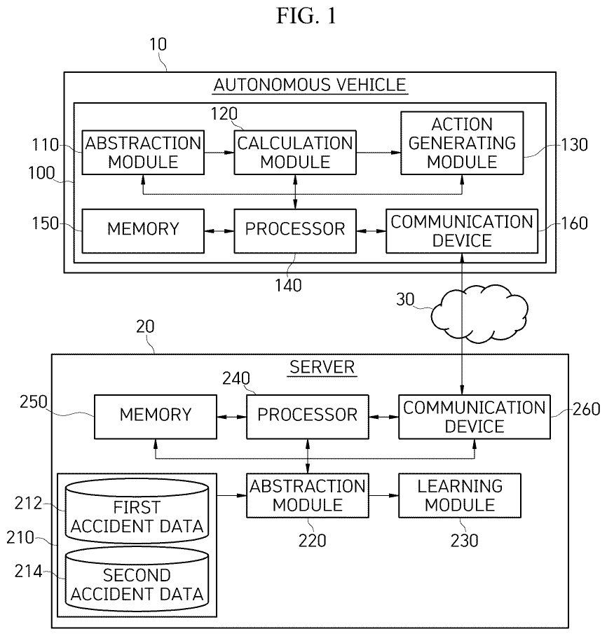

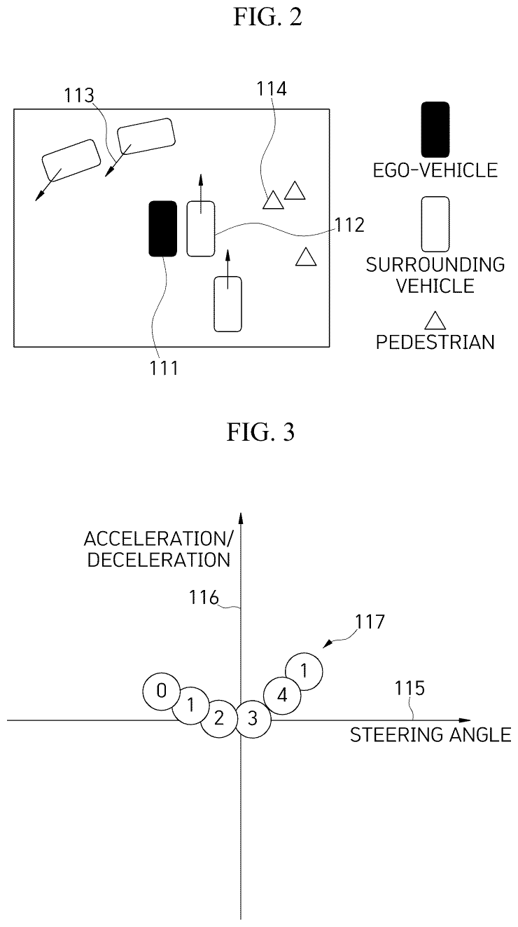

FIG. 1 is a block diagram of a whole system for predicting a possibility of an accident in real time during vehicle driving, according to an embodiment of the present invention. FIG. 2 is a diagram for describing environment data abstracted by an abstraction module of FIG. 1. FIG. 3 is a diagram for describing action data abstracted by the abstraction module of FIG. 1.

Referring to FIG. 1, a whole system according to an embodiment of the present invention may include an autonomous vehicle 10 (hereinafter referred to as an ego-vehicle) and a server 20 which communicates with the ego-vehicle 10 over a network 30. The network 30 may be a wireless network.

### Ego-Vehicle 10

An accident prediction apparatus 100 for predicting a possibility of an accident in real time during driving of the ego-vehicle 10 may be equipped in the ego-vehicle 10. The accident prediction apparatus 100 may include an abstraction module 110, a calculation module 120, an action generating module 130, a processor 140, a memory 150, and a communication device 160, so as to predict a possibility of an accident in real time. Although not shown in FIG. 1, the accident prediction apparatus 100 may further include a sensor. Here, the sensor may include a sensor which measures a surrounding situation of the ego-vehicle 10, and for example, may include a radar sensor, a Lidar sensor, a camera, and an ultrasound sensor. Also, the sensor may further include a sensor which measures the movement of a vehicle, and for example, may further include a steering angle sensor, a velocity sensor, a gyro sensor, and a pose measurement sensor.

The abstraction module 110 may be a module which be executed and controlled by the processor 140 and may be implemented as a hardware module, a software module, or a combination thereof.

The abstraction module 110 may abstract surrounding situation data and movement data of the ego-vehicle input from the sensor to generate abstracted driving situation data. Here, abstraction may denote a data processing operation which expresses data as a simple figure such as dots, a line, a triangle, a tetragon, or a circle, or expresses data as a two-dimensional (2D) or three-dimensional (3D) coordinate system (or graph).

The surrounding situation data may include, for example, sensor data measured by a radar sensor, a Lidar sensor, a camera, or an ultrasound sensor. The movement data may include, for example, sensor data measured by a steering angle sensor, a velocity sensor, a gyro sensor, or a pose measurement sensor.

The abstraction module 110 may generate abstracted environment data where surrounding situation data of the ego-vehicle is expressed as a simple figure, based on the abstraction, and may generate abstracted action data where the movement data of the ego-vehicle 10 is expressed in the coordinate system (or graph). Also, the abstraction module 110 may generate the abstracted driving situation data configured to include the abstracted environment data and the abstracted action data.

The abstracted environment data may include, for example, tetragons 111 and 112 expressing the ego-vehicle 10 and a surrounding vehicle, a line expressing a traveling direction of each of the tetragons 111 and 112, and a triangle 114 expressing a pedestrian as illustrated in FIG. 2. The FIGS. 111 to 114 may each be expressed in a top-view form. Alternatively, the FIGS. 111 to 114 may be expressed in a form which is projected on a cylindrical virtual screen with respect to the ego-vehicle 10. The amount of data may decrease through an abstraction operation.

The abstracted action data may include, for example, time-series data 117 which is expressed in a 2D coordinate system including an x axis 115 representing first movement data of the ego-vehicle 10 and a y axis 116 representing second movement data of the ego-vehicle 10 as illustrated in FIG. 3. Here, the first movement data may be, for example, a handle steering angle, and the second movement data may be acceleration/deceleration of the ego-vehicle 10. In this case, the time-series data may be data which time-serially expresses an acceleration/deceleration variation rate of the handle steering angle.

The abstracted driving situation data including the abstracted environment data and the abstracted action data may be data which is implemented in an image form or a table form.

Referring again to FIG. 1, the calculation module 120 may calculate a digitized score of a possibility of an accident of the ego-vehicle 10, based on the abstracted driving situation data input from the abstraction module 110.

The calculation module 120 may include a deep learning model which is trained by the server 20 to calculate a digitized score of a possibility of an accident of the ego-vehicle 10, based on the abstracted driving situation data.

For learning of the deep learning model, the abstracted environment data of FIG. 2 and the abstracted action data of FIG. 3 which are previously collected may be used learning data (or training data). In this case, a time taken until the ego-vehicle 10 reaches a destination or a distance to the destination from the ego-vehicle 10 may be further used as learning data. The reason that the data is further used as learning data may be for allowing the deep learning model not to calculate a stop state of the ego-vehicle 10 as a score representing a safest state. Therefore, the deep learning model may be trained to calculate a score representing a possibility of an accident during only driving of an ego-vehicle.

Moreover, the calculation module 120 may provide guide data which guides an accident-causing action for increasing a possibility of an accident of the ego-vehicle 10. In this case, the calculation module 120 may be trained by the server 20 to provide the guide data guiding an accident-causing action of the ego-vehicle 10, based on the abstracted driving situation data. When the ego-vehicle 10 drives similar to the accident-causing action provided from the calculation module 120, a possibility of an accident of the ego-vehicle 10 may increase.

The action generating module 120 may generate action data of the ego-vehicle 10, based on at least one of the guide data guiding the accident-causing action and the score representing a possibility of an accident calculated by the calculation module 120. The action data may be data for decreasing the possibility of the accident, and for example, may include steering angle data and acceleration/deceleration data for decreasing the possibility of the accident.

The processor 140 may be an arithmetic chip which executes and controls operations of the abstraction module 110, the calculation module 120, and the action generating module 130 and may include at least one CPU, at least one graphics processing unit (GPU), and at least one application processor.

The memory 150 may be a device which stores instructions needed for executing and controlling operations of the abstraction module 110, the calculation module 120, and the action generating module 130 by using the processor 140 and may include a volatile memory and/or a non-volatile memory.

The communication device 160 may be a device which receives a prediction function from the server 20 through wireless communication (for example, vehicle-to-infrastructure (V2I) communication), so that the prediction function trained to calculate a digitized score of a possibility of an accident of the ego-vehicle 10 is installed in the calculation module 120.

### Server 20

The server 20 may train the prediction function for predicting the possibility of the accident and may transmit the trained prediction function to the ego-vehicle 10 over the network 30. To this end, the server 20 may include a collection module 210, an abstraction module 220, a learning module 230, a processor 240, a memory 250, and a communication device 260.

The collection module 210 may be a module which collects vehicle accident data and may be a non-volatile storage medium. Here, the vehicle accident data may include first accident data 212 and second accident data 214.

The first accident data may be data which is simulated a simulator (not shown in FIG. 1), and the second accident data may be image data based on an image device (not shown in FIG. 1). Here, the image device may be a black box or a closed-circuit television (CCTV).

The simulator may simulate an accident occurring between a virtual normal driving vehicle and a virtual abnormal driving vehicle to generate the first accident data 212. Here, the virtual abnormal driving vehicle may denote a virtual object which is programmed to drive at a rapid acceleration or a rapid deceleration in a virtual simulation environment.

The abstraction module 220 may have the same function as that of the abstraction module 110 included in the ego-vehicle 10. That is, the abstraction module 220 may abstract the vehicle accident data including the first and second accident data 212 and 214 to generate abstracted driving situation data.

The abstracted driving situation data may include abstracted environment data where the vehicle accident data is expressed as a figure and abstracted action data where the vehicle accident data is expressed in a coordinate system.

The learning module 230 may train the prediction function to calculate a score representing a possibility of an accident of the ego-vehicle 10 by using the abstracted driving situation data as learning data (or training data), based on a deep learning method. Here, the deep learning method may use, for example, a long short-term memory (LSTM) method.

In an embodiment, the prediction function may be trained by the learning module 230 to calculate a first accident score based on the abstracted environment data and a second accident score based on the abstracted action data. As described above, the prediction function may be trained to individually calculate the first accident score based on the abstracted environment data and the second accident score based on the abstracted action data.

In an embodiment, the prediction function may be trained to merge the first accident score and the second accident score to calculate a final accident score. Accordingly, an accident risk level may be precisely predicted. Here, merging of the first accident score and the second accident score may be an addition, multiplication, or convolution operation.

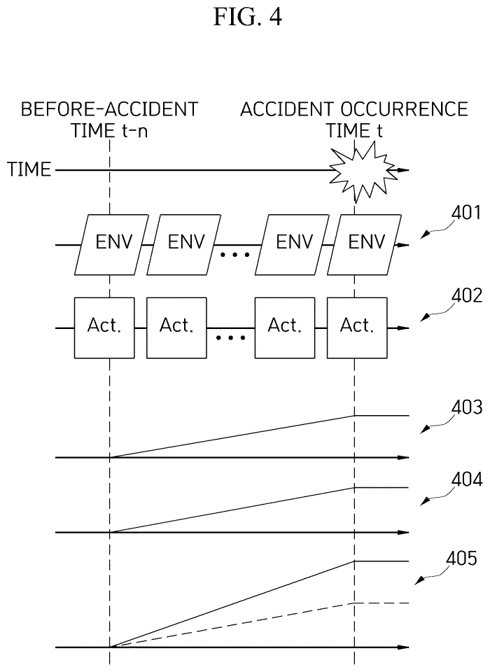

In an embodiment, the prediction function may precisely predict an accident risk level by using all of the first accident score, the second accident score, and the final accident score. FIG. 4 is a diagram for describing a first accident score, a second accident score, and a final accident score each calculated by a prediction function according to an embodiment of the present invention. A reference numeral 401 may refer to the abstracted environment data, a reference numeral 402 may refer to the abstracted action data, a reference numeral 403 may refer to a first accident score based on the abstracted environment data, and a reference numeral 404 may refer to a second accident score based on the abstracted action data. Also, a reference numeral 405 may refer to a final accident score obtained by merging the first accident score and the second accident score.

A process of obtaining data for training the prediction function in the learning module 230 will be described below. First, the abstraction module 220 may read the first accident data and the second accident data from the collection module 210. In this case, because the first accident data is data collected by simulation, the first accident data may include data before an accident occurs, and because the second accident data is accident data which occurs actually, the second accident data may not sufficiently include data before an accident occurs.

In the present invention, as the prediction function is trained by using all of the first and second accident data, there may be only data at a time at which an accident occurs, and the prediction function may be robustly trained despite a situation where data before an accident occurs is insufficient. That is, the data before the accident occurs may be obtained from simulation data despite a situation where there is only the first accident data which is accident data which actually occurs, and thus, the prediction function may be robustly trained by using the data as sufficient learning data up to a time, at which an accident occurs, from a time before an accident occurs.

Moreover, the learning module 230 may train the prediction function to provide guide data for avoiding an accident caused by an accident-causing action by using the abstracted driving situation data as learning data (or training data). Here, the guide data may include action data of the ego-vehicle 10 such as a steering angle and an acceleration/deceleration for decreasing a probability of an accident.

The processor 240 may be an arithmetic chip which executes and controls operations of the collection module 210, the abstraction module 220, and the learning module 230 and may include at least one CPU, at least one GPU, and at least one application processor.

The memory 250 may be a device which stores instructions needed for executing and controlling operations of the collection module 210, the abstraction module 220, and the learning module 230 by using the processor 240 and may include a volatile memory and/or a non-volatile memory.

The communication device 260 may transmit the trained prediction function to the server 20 through wireless communication such as V2I communication, so that the trained prediction function is installed in the calculation module 120.

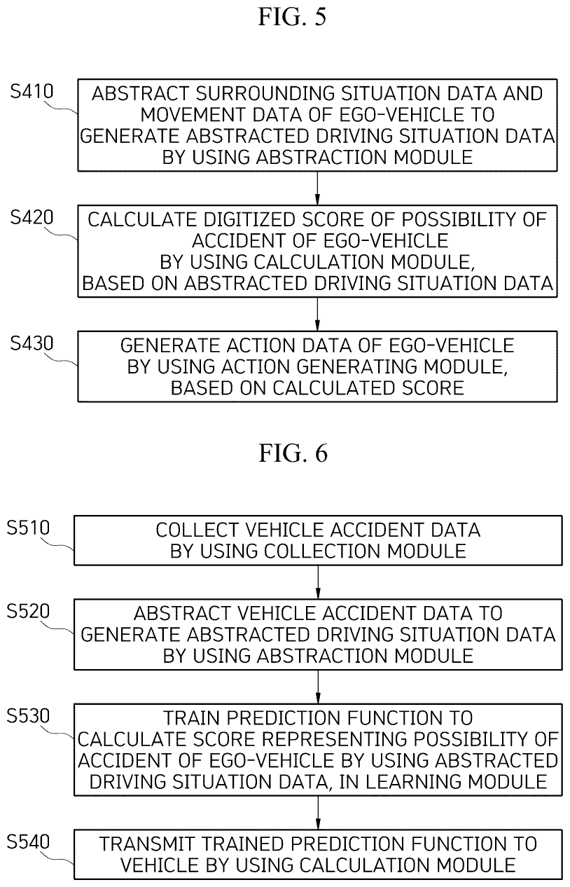

FIG. 5 is a flowchart for describing a method of predicting a possibility of an accident in real time during vehicle driving, according to an embodiment of the present invention.

Referring to FIG. 5, first, at step S410, a process of abstracting surrounding situation data and movement data of an ego-vehicle input from a sensor to generate abstracted driving situation data by using the abstraction module 110 executed by the processor 140 may be performed.

Subsequently, at step S420, a process of calculating a digitized score of a possibility of an accident of the ego-vehicle by using the calculation module 120 executed by the processor 140 on the basis of the abstracted driving situation data may be performed.

Subsequently, at step S430, a process of generating action data of the ego-vehicle for decreasing the possibility of the accident on the basis of the score may be performed in the action generating module 130 executed by the processor 140.

In an embodiment, the process (S410) of generating the abstracted driving situation data may include a process of generating abstracted environment data where the surrounding situation data of the ego-vehicle is expressed as a figure, a process of generating abstracted action data where the movement data of the ego-vehicle is expressed in a coordinate system, and a process of generating the abstracted driving situation data configured to include the abstracted environment data and the abstracted action data.

In an embodiment, the figure may include dots, a line, a triangle, a tetragon, and a circle.

In an embodiment, the coordinate system may be a 2D coordinate system including an x axis representing first movement data of the ego-vehicle and a y axis representing second movement data of the ego-vehicle.

In an embodiment, the abstracted driving situation data may be data which is implemented in an image form or a table form.

In an embodiment, the process (S430) of generating the action data of the ego-vehicle may include a process of generating the action data of the ego-vehicle for decreasing the possibility of the accident of the ego-vehicle.

In an embodiment, the process (S430) of generating the action data of the ego-vehicle may include a process of generating the action data of the ego-vehicle, based on guide data which guides an accident-causing action of the ego-vehicle.

In an embodiment, the process (S420) of calculating the digitized score of the possibility of the accident of the ego-vehicle may further include a process of providing the guide data.

FIG. 6 is a flowchart for describing a method of learning a possibility of an accident during vehicle driving, according to an embodiment of the present invention.

Referring to FIG. 6, first, at step S510, a process of collecting vehicle accident data may be performed in the collection module 210 controlled by the processor 240.

Subsequently, at step S520, a process of abstracting the vehicle accident data to generate abstracted driving situation data may be performed in the abstraction module 220 controlled by the processor 240.

Subsequently, at step S530, a process of training a prediction function to calculate a score representing a possibility of an accident of an ego-vehicle by using the abstracted driving situation data as learning data may be performed in the learning module 230 controlled by the processor 240.

Subsequently, at step S540, a process of transmitting the trained prediction function to the vehicle 10 to install the trained prediction function in the calculation module 120 of the vehicle 10 may be performed in the communication device 260 controlled by the processor 240.

In an embodiment, the process (S510) of collecting the vehicle accident data may a process of collecting the vehicle accident data including first accident data simulated by simulation and second accident data obtained by an image device.

In an embodiment, the first accident data may include data which is obtained by simulating an accident occurring between a virtual normal driving vehicle and a virtual abnormal driving vehicle.

In an embodiment, the second accident data may include data which is obtained by photographing a real accident with the image device including a black box or a CCTV.

In an embodiment, the process (S520) of generating the abstracted driving situation data may include a process of generating abstracted environment data where the vehicle accident data is expressed as a figure, a process of generating abstracted action data where the vehicle accident data is expressed in a coordinate system, and a process of generating the abstracted driving situation data including the abstracted environment data and the abstracted action data.

In an embodiment, the process (S530) of training the prediction function may include a process of training the prediction function by using an LSTM method.

According to the embodiments of the present invention, a possibility of an accident may be detected in real time, and thus, an autonomous driving system may quickly respond to an accident caused by an unpredicted situation.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of predicting a possibility of an accident, the method comprising:
abstracting surrounding situation data and movement data of an ego-vehicle input from a sensor to generate abstracted driving situation data by using an abstraction module executed by a processor;
calculating a digitized score of a possibility of an accident of the ego-vehicle by using a calculation module executed by the processor, based on the abstracted driving situation data; and
generating action data of the ego-vehicle for decreasing the possibility of the accident by using an action generating module executed by the processor, based on the score.

2. The method of claim 1, wherein the generating of the abstracted driving situation data comprises:
generating abstracted environment data where the surrounding situation data of the ego-vehicle is expressed as a figure;
generating abstracted action data where the movement data of the ego-vehicle is expressed in a coordinate system; and
generating the driving situation data configured to include the abstracted environment data and the abstracted action data.

3. The method of claim 2, wherein the figure comprises dots, a line, a triangle, a tetragon, and a circle.

4. The method of claim 2, wherein the coordinate system is a two-dimensional (2D) coordinate system including an x axis representing first movement data of the ego-vehicle and a y axis representing second movement data of the ego-vehicle.

5. The method of claim 1, wherein the abstracted driving situation data is data implemented in an image form or a table form.

6. The method of claim 1, wherein the generating of the action data of the ego-vehicle comprises generating the action data of the ego-vehicle for decreasing the possibility of the accident of the ego-vehicle.

7. The method of claim 6, wherein the generating of the action data of the ego-vehicle comprises generating the action data of the ego-vehicle, based on guide data for avoiding an accident caused by an accident-causing action of the ego-vehicle.

8. The method of claim 7, wherein the calculating of the digitized score of the possibility of the accident of the ego-vehicle further comprises providing the guide data.

9. A method of learning a possibility of an accident, the method comprising:
collecting vehicle accident data by using a collection module controlled by a processor;
abstracting the vehicle accident data to generate abstracted driving situation data by using an abstraction module controlled by the processor;
training a prediction function to calculate a score representing a possibility of an accident of an ego-vehicle by using the abstracted driving situation data as learning data in a learning module controlled by the processor; and
transmitting the trained prediction function to the ego-vehicle to install the trained prediction function in a calculation module of the ego-vehicle by using a communication device controlled by the processor.

10. The method of claim 9, wherein the collecting of the vehicle accident data comprises collecting the vehicle accident data including first accident data simulated by simulation and second accident data obtained by an image device.

11. The method of claim 10, wherein the first accident data comprises data obtained by simulating an accident occurring between a virtual normal driving vehicle and a virtual abnormal driving vehicle.

12. The method of claim 10, wherein the second accident data comprises data obtained by photographing a real accident with the image device including a black box or a closed-circuit television (CCTV).

13. The method of claim 9, wherein the generating of the abstracted driving situation data comprises:
generating abstracted environment data where the vehicle accident data is expressed as a figure;
generating abstracted action data where the vehicle accident data is expressed in a coordinate system; and
generating the abstracted driving situation data including the abstracted environment data and the abstracted action data.

14. The method of claim 9, wherein the training of the prediction function comprises training the prediction function by using a long short-term memory (LSTM) method.

15. An apparatus for predicting a possibility of an accident, the apparatus comprising:
a processor;
an abstraction module executed by the processor and configured to abstract surrounding situation data and movement data of an ego-vehicle input from a sensor to generate abstracted driving situation data;
a calculation module executed by the processor and configured to calculate a digitized score of a possibility of an accident of the ego-vehicle, based on the abstracted driving situation data; and
an action generating module executed by the processor and configured to generate action data of the ego-vehicle for decreasing the possibility of the accident, based on the score.

16. The apparatus of claim 15, wherein the abstraction module is configured to express the surrounding situation data of the ego-vehicle as a figure to generate the abstracted driving situation data representing the figure.

17. The apparatus of claim 15, wherein the abstracted driving situation data is data implemented in an image form or a table form.

18. The apparatus of claim 15, wherein the calculation module is further configured to output guide data for avoiding an accident caused by an accident-causing action of the ego-vehicle.

19. The apparatus of claim 18, wherein the action generating module is configured to generate action data of the ego-vehicle, based on the guide data.
